(19) United States
(12) Patent Application Publication
(10) Pub. No.: US 2004/0083406 A1
(43) Pub. Date: Apr. 29, 2004

(54) Multifunction product and method for use in multifunction product

(75) Inventor: Tetsuya Goto, Fuji-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/278,935

(22) Filed: Oct. 24, 2002

(51) Int. Cl. H04L 1/22

(52) U.S. Cl. 714/25

(57) ABSTRACT

Whether or not parts or functions designated by a designating section are operating normally is self-diagnosed by executing tests. Diagnosed results are stored in a storage section along with dates and times read from a clock section, for each part or function. The diagnosed results, dates, and times of the parts or functions stored at this time and diagnosed results, dates, and times of other parts or functions are read from the storage section. Printing data distinguishing and printing the diagnosed results, dates, and times of the parts or functions stored at this time and the diagnosed results, dates, and times of the other parts or functions is prepared, and is output to a printer.

### BACKGROUND OF THE INVENTION

1. Field of the Invention

The present invention relates to a multifunction product and to a method for use in a multifunction product which carries out self-diagnoses of parts or functions thereof, and which prints the results of the self-diagnoses.

2. Description of the Related Art

A multifunction product is configured such that a communication function is built into the device in accordance with developments in communication technology. The communication function built into the multifunction product has been a communication function which is similar to a local printer function in which the multifunction product is directly connected to a personal computer by a cable and receives data, or to a communication function by a telephone line such as a telephone function, a facsimile function, or the like.

Further, there are recent multifunction products in which, in addition to the communication function by a telephone line, a LAN (local area network) function, in which the multifunction product is connected to a network and can be used from anywhere in an office, is used.

In this way, recently, various types of functions have been required of the multifunction product, and the types of functions built into one multifunction product have increased. As the multifunction product, there are multifunction products in which, for example, a self-diagnostic function is built in.

The self-diagnostic function is a function in which the multifunction product self-diagnoses whether or not the operations of a plurality of parts or functions constituting the multifunction product are normal. When a problem arises in the device, the user grasps the operating situations of one or a plurality of parts or functions by using the self-diagnostic function, and contacts a service-person who is in charge of repairs, or the like when the parts or functions which are not operating normally cannot be restored.

However, parts or functions for which a large number of diagnoses are required are built into the multifunction product, and if diagnoses are carried out for all of the object parts or functions at one time of diagnosing, a long time is spent for the diagnosing. Accordingly, it is inefficient to carry out diagnoses of all of the parts and the functions each time.

Thus, when a problem arises in the device, the user preferably focuses on the causes of the trouble to some extent, and carries out diagnoses only for the parts or functions for which it is supposed that diagnosis is needed.

However, if diagnoses are carried out in this way only for parts or functions for which it is supposed that diagnosis is needed and the diagnosed results are printed, the situations of the other parts or functions which are not diagnosed cannot be grasped at all.

### BRIEF SUMMARY OF THE INVENTION

In a multifunction product, it has been desired that, when diagnoses of parts or functions for which it is supposed that diagnoses are needed are carried out, both the diagnosed results and the past diagnosed results of other parts or functions which are not diagnosed at this time are printed, and the diagnosed results of this time and the past diagnosed results of the other parts or functions are printed so as to be distinguishable from one another.

According to an aspect of the invention, parts or functions to be diagnosed are individually designated from among a plurality of parts or functions constituting the device. Further, whether or not parts or functions designated by a designating section are operating normally is self-diagnosed by executing tests. The diagnosed results are stored in a storage section for each part or function, along with a date and time read from a clock section. When diagnosed results and dates and times of parts or functions are newly stored in the storage section, the latest diagnosed results and dates and times of the parts or the functions, being previously stored in the storage section, other than the parts or functions diagnosed at this time, are read. Further, the read contents are combined with the diagnosed results of the parts or functions diagnosed at this time, and the diagnosed results of the respective parts or functions are rearranged in order of the dates, and are printed out.

According to an aspect of the invention, when diagnosed results and dates and times of parts or functions are newly stored in a storage section, the latest diagnosed results and dates and times of the parts or the functions, being previously stored in the storage section, other than the parts or functions diagnosed at this time, are read. Further, the read contents are combined with the diagnosed results of the parts or functions diagnosed at this time, and the diagnosed results of the parts or functions diagnosed at this time are printed in an emphasized manner so as to be distinguished from the diagnosed results of the parts or functions other than the parts or functions diagnosed at this time.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a multifunction product showing an embodiment of the present invention.

FIG. 2 is a diagram showing a configuration of a test results storage section for use in the embodiment.

FIG. 3 is a flowchart showing test executing processing for diagnosis by a CPU of the embodiment.

FIG. 4 is a flowchart showing printing processing of test results by the CPU of the embodiment.

FIG. 5 is a diagram showing a printed example of test results in the embodiment.

FIG. 6 is a diagram showing a comparative example in which test results are printed without editing.

FIG. 7 is a diagram showing another printed example of test results in the embodiment.

### DETAILED DESCRIPTION OF THE INVENTION

A multifunction product according to an embodiment of the present invention will be described with reference to the drawings.

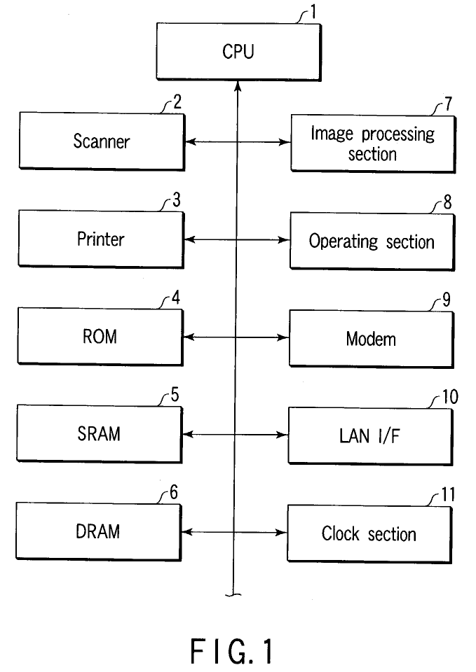

FIG. 1 is a block diagram showing a configuration of the multifunction product.

A CPU (central processing unit) 1 constitutes a control section main body and carries out system control. A scanner 2 is comprises, for example, a CCD (charge coupled device), and reads an original to be set and converts it into image data and outputs the data.

A printer 3 is a page printer for printing out image data or text data in units of pages. A ROM (read only memory) 4 includes a portion of a flash ROM, and stores program data by which the CPU 1 controls the respective sections, or program data for executing communication processes. An SRAM (static random access memory) 5 is provided with a storage section for storing test results of diagnoses of respective parts or functions which are objects of diagnosis, and the like.

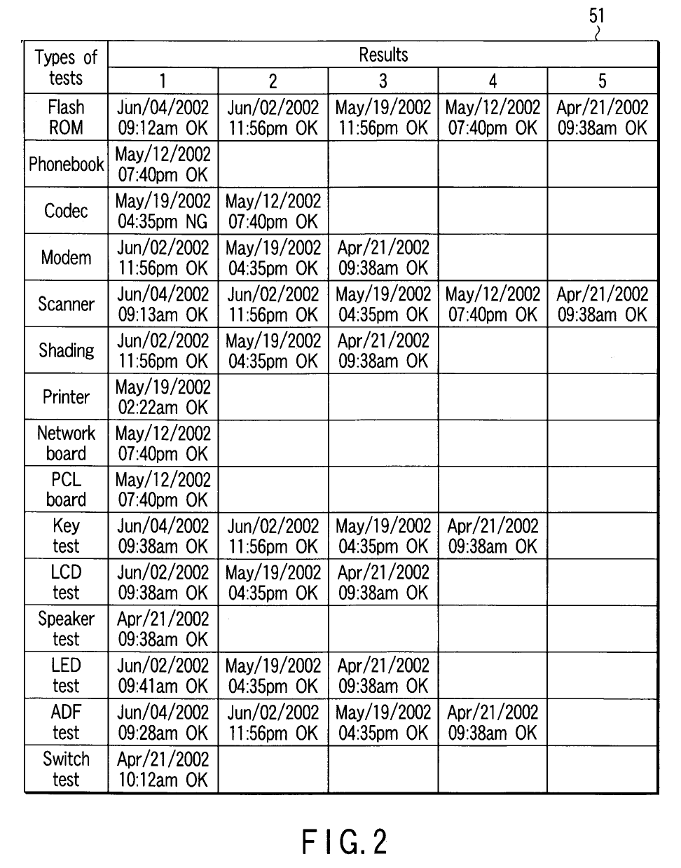

As the storage section for storing the test results, as shown in FIG. 2, for example, a test results storage section 51, which stores the past 5 times of test results of the respective parts or functions which are objects of diagnosis, along with the dates and times, is used.

A DRAM (dynamic random access memory) 6 forms a memory in which a page buffer or image data to be used by the printer 3 are temporarily stored, or the like. An image processing section 7 carries out processings of encoding and decoding of image data.

An operating section 8 has various types of keys such as a numeric keypad for inputting a telephone number or the like, one-touch keys, and a start key, and a display section. A modem 9 has both a high-speed and low-speed modem function for sending and receiving facsimile signals or the like, and a data communication modem function for carrying out communication with a provider. A LAN interface 10 is connected to a digital line such as a LAN or the like, and carries out sending and receiving of digital data. A clock section 11 clocks the year/month/date which is the date, and the time.

The CPU 1 and the scanner 2, printer 3, ROM 4, SRAM 5, DRAM 6, image processing section 7, operating section 8, modem 9, LAN interface 10, and clock section 11 are electrically connected to one another by a bus line 12.

In the CPU1, as shown in FIG. 2, there are a Flash ROM, Phonebook function, Codec function, Modem, Scanner, Shading function, Printer, Network board, PCL board, Key test, LCD (liquid crystal display) test, Speaker test, LED (light emitting diode) test, ADF test, and Switch test as the types of the tests which diagnose the respective parts or functions.

The various types of tests for the diagnoses are designated by key operations of the operating section 8. In other words, the operating section 8 configures a designating section for individually designating parts or functions to be diagnosed from among the plurality of parts or functions constituting the device.

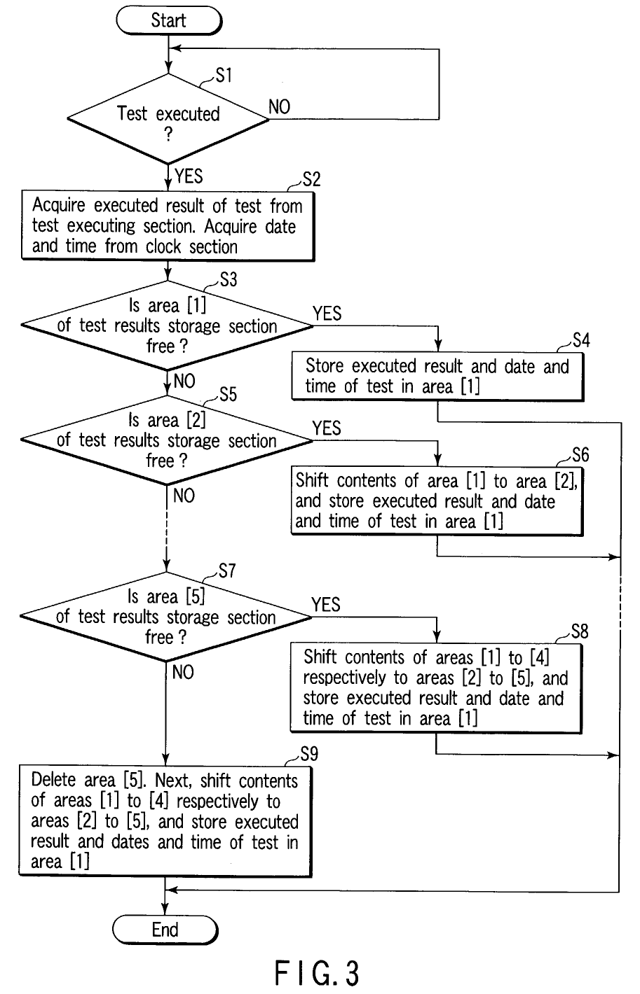

When the parts or functions to be diagnosed are designated by key operations of the operating section 8, the CPU 1 carries out the test executing processing for diagnoses shown in FIG. 3 in accordance with a program. The program function of the test executing processing shown in FIG. 3 configures a diagnosing section for self-diagnosing whether or not parts or functions are operating normally by executing tests.

When the parts or functions to be diagnosed are designated by key operations of the operating section 8 and the tests are executed, the CPU 1 determines executing of the tests in S1. Then, in S2, the executed results of the tests are acquired from a test executing section which is a program function of executing the tests. Further, the dates and times are acquired from the clock section 11.

Subsequently, the CPU 1 checks the free state of area [1] at the types of the executed tests of the test results storage section 51, in S3. As a result, if area [1] is free, in S4, the executed result of the test, and the date and time are stored in area [1]. For example, if the type of the executed test is “Network board”, and today's date is May 12, 2002, and the time is 7:40 pm, and the result of the test is OK, the data of May/12/2002, 07:40 pm, OK is stored in area [1]. When the data is stored, the series of processings is completed.

Alternatively, if area [1] is not free, the CPU 1 then checks the free state of area [2] in S5. As a result, if area [2] is free, in S6, the contents of area [1] are shifted to area [2], and the executed result of the test and the date and time are stored in area [1] which has been freed up. When the data is stored, the series of processings is completed.

If area [2] is not free, next, the CPU 1 checks the free state of area [3]. In this way, the CPU 1 successively checks the free states of areas [1] to [4], and if they are not free, finally, in S7, the CPU 1 checks the free state of area [5]. Further, if area [5] is free, in S8, the contents of areas [1] to [4] are respectively shifted to areas [2] to [5], and the executed result of the test and the date and time are stored in area [1] which has been freed up. When the data is stored, the series of processings is completed.

Further, if area [5] is not free, in S9, the contents of area [5] are deleted, and the contents of areas [1] to [4] are respectively shifted to areas [2] to [5], and the executed result of the test and the date and time are stored in area [1] which has been freed up. When the data is stored, the series of processings is completed.

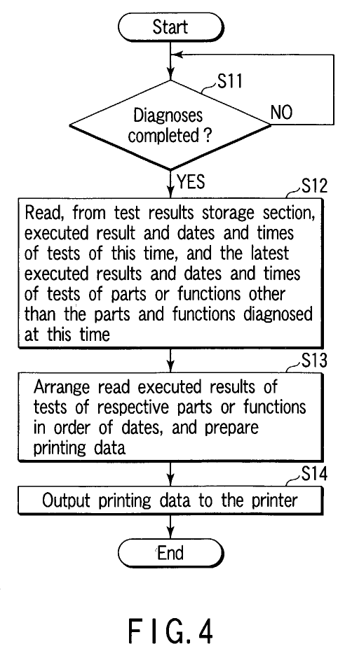

When execution of the series of tests for the parts or functions designated by key operations is completed and the executed results and the date and time of the tests are stored in the test results storage section 51, the CPU 1 determines that it is the end of the diagnoses. Further, the printing processing of the executed results of the tests shown in FIG. 4 is carried out.

That is, when the end of the diagnoses is determined in S11, in S12, the CPU 1 reads the executed results and the dates and times of the tests of this time stored in the test results storage section 51, and reads the latest executed results and dates and times of the tests of the parts or functions other than the parts or functions diagnosed at this time. Thereafter, in S13, printing data is prepared by carrying out editing in which the read executed results of the tests of the respective parts or functions are rearranged in order of the dates thereof, and in S14, the printing data is output to the printer 3. In this way, the processing program of FIG. 4 by the CPU 1 configures a printing data editing section.

For example, if diagnoses of Flash ROM, Scanner, ADF test, and Key test were successively carried out from 9:12 am to 9:38 am of today, Jun/04/2002, the CPU 1 stores the executed results of the tests in the corresponding areas of the test results storage section 51.

Then, the CPU 1 reads the diagnosed results and the dates and times of this time from the test results storage section 51. In other words, the CPU 1 reads “Flash ROM, OK, Jun/04/2002 09:12 am”, “Scanner, OK, Jun/04/2002 09:13 am”, “ADF test, OK, Jun/04/2002 09:28 am”, and “Key test, OK, Jun/04/2002 09:38 am”.

Further, the CPU 1 reads the diagnosed results and the dates and times of the latest tests of the parts or functions other than the parts or functions diagnosed at this time from the test results storage section 51. In other words, the CPU 1 reads “Phonebook, Okla., May/12/2002 07:40 pm”, “Codec, NG, May/19/2002 04:35 pm”, “Modem, OK, Jun/02/2002 11:56 pm”, “Shading, OK, Jun/02/2002 11:56 pm”, “Printer, OK, May/19/2002 02:22 am”, “Network board, OK, May/12/2002 07:40 pm”, “PCL board, OK, May/12/2002 07:40 pm”, “LCD test, OK, Jun/02/2002 09:38 am”, “Speaker test, OK, Apr/21/2002 09:38 am”, “LED test, NG, Jun/02/2002 09:41 am”, and “Switch test, OK, Apr/21/2002 10:12 am”.

The CPU 1 then carries out editing in which these read test results are rearranged in order of the dates thereof. That is, the results of the four types of tests diagnosed at this time are arranged in order starting from the latest. Next, the results of the eleven types of tests which carried out diagnoses before are grouped in order of the dates, and each group is arranged in order starting from the latest. Further, the edited test results are outputted as printing data to the printer 3.

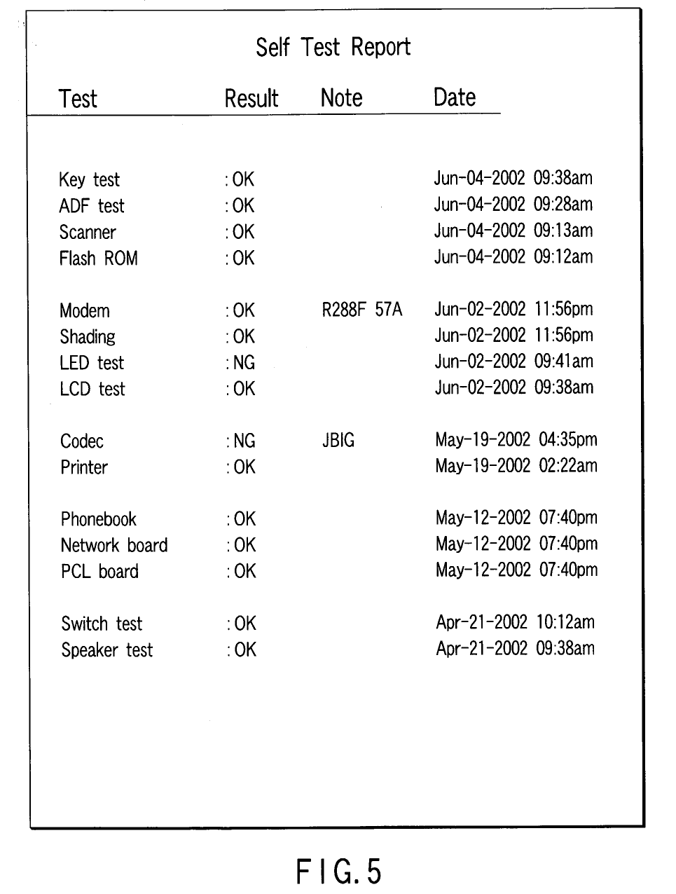

The printer 3 prints out the printing data on recording paper. The printed results on the recording paper at this time are as shown in FIG. 5. Note that items of special mention are printed as notes, in addition to the types of the tests, the results, and the dates.

In this way, the multifunction product can designate some of the parts or functions for which it is supposed that diagnosis is needed from among a large number of parts or functions which are objects to be diagnosed, and can execute the tests. Therefore, the multifunction product can diagnose efficiently.

When printing is carried out on recording paper, because not only the results of the four types of tests at this time, but also the results of the other eleven types of tests diagnosed previously are printed, an operator can grasp all of the diagnosed results including the diagnosed results of this time. Accordingly, the operator can grasp the overall situations of the parts or functions.

In addition, when printing is carried out on recording paper, because all of the results are grouped in order of the dates and each group is arranged in order from the latest, the results of the four types of tests of this time and the results of the other eleven types of tests previously diagnosed can be easily distinguished and confirmed. Further, for the results of the other eleven types of tests as well, it can be easily grasped in units of groups when diagnosis was carried out.

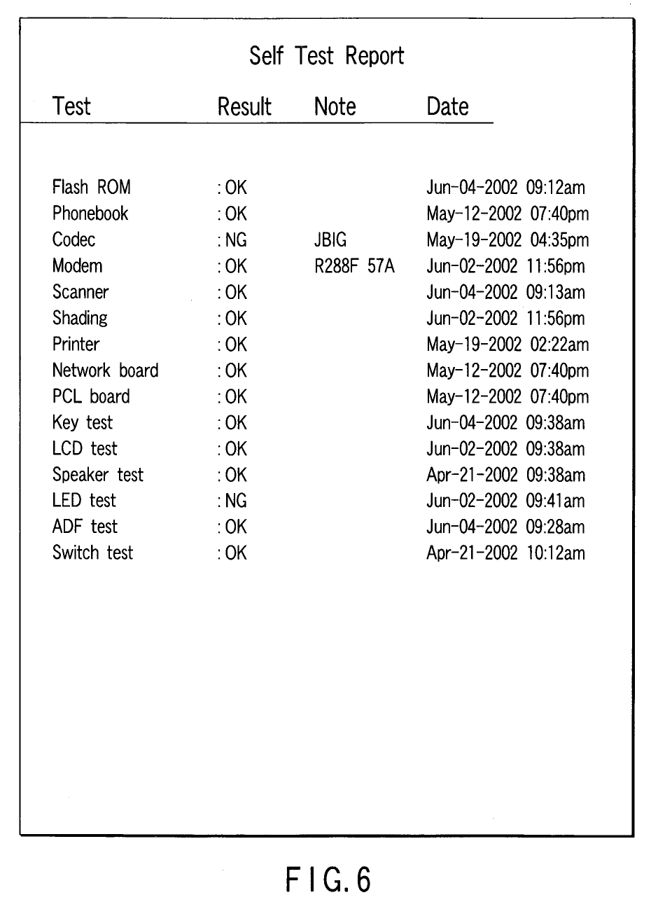

For example, as shown as a comparative example in FIG. 6, when the test results read from the test results storage section 51 are printed with no editing at all, it is extremely troublesome to determine which types are diagnosed at this time from among all of the results.

Further, because the test results and dates and times of the past five times for the fifteen types of objects of diagnosis can be stored in the test results storage section 51, if all of the data of the test results storage section 51 is printed for each object of diagnosis, the past diagnosis histories of the respective diagnosed parts or functions can be grasped. Accordingly, diagnosis history information is effective when determining timings for replacing or repairing the parts and adjusting the functions.

Note that, in the embodiment, when the test results of the fifteen types of objects of diagnosis are printed on recording paper, they all are grouped in order of the dates and each group is arranged in order starting from the latest. Thus, the results of the four types of tests of this time and the results of the other eleven types of tests for which diagnoses were previously carried out can be easily distinguished and verified. However, the present invention is not limited to the same.

For example, the diagnosed results of this time may be printed in an emphasized manner such that the diagnosed results of the parts or functions diagnosed at this time can be distinguished from the latest diagnosed results of the parts or functions other than the parts or functions diagnosed at this time. As a method of emphasizing, there are a method of printing the characters in bold type, a method of adding a mark or a symbol, a method of adding an underline, a method of changing the size or the font of the characters, and the like.

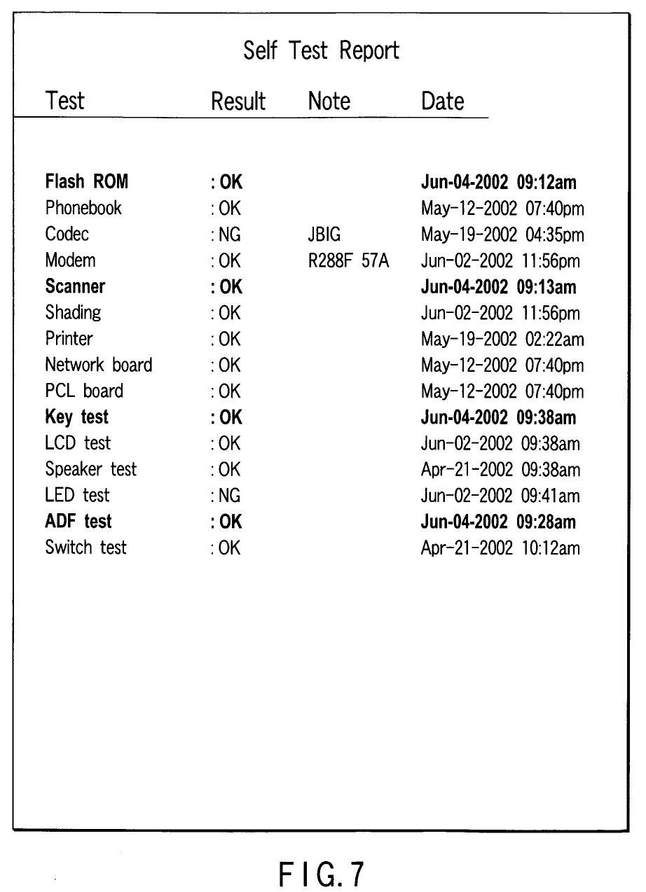

When the method of printing the characters in bold type is used, for example, printing on recording paper is as shown in FIG. 7. In this way as well, the results of the four types of tests which were the objects of diagnosis at this time, namely “Flash ROM, OK, Jun/04/2002 09:12 am”, “Scanner, OK, Jun/04/2002 09:13 am”, “ADF test, OK, Jun/04/2002 09:28 am”, and “Key test, OK, Jun/04/2002 09:38 am” can be easily distinguished from the results of the other eleven types of tests for which diagnoses were previously carried out, and can be verified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multifunction product comprising:
a designating section which individually designates parts or functions to be diagnosed from among a plurality of parts or functions constituting a device;
a diagnosing section which self-diagnoses whether or not one or more parts or functions designated by the designating section are operating normally, by executing tests;
a clock section which counts a date and time;
a storage section which stores results diagnosed by the diagnosing section, along with the date and time read from the clock section for each part or function;
a printer which prints out printing data;
a reading section which, when diagnosed results and dates and times of one or more parts or functions are newly stored in the storage section, reads the diagnosed results, dates, and times of the one or more parts or functions diagnosed at this time, and diagnosed results, dates, and times of parts or functions other than the one or more parts or functions diagnosed at this time, from the storage section; and
a printing data editing section which prepares and outputs, to the printer, printing data which distinguishes and prints the diagnosed results, dates, and times of the one or more parts or functions diagnosed at this time read by the reading section, and the diagnosed results, dates, and times of the parts or functions other than the one ore more parts or functions diagnosed at this time.

2. A multifunction product according to claim 1, wherein
the printing data editing section rearranges the diagnosed results, dates, and times of the one or more parts or functions diagnosed at this time, and the diagnosed results, dates, and times of the parts or functions other than the one or more parts or functions diagnosed at this time, in order of the dates, and distinguishes them from one another.

3. A multifunction product according to claim 1, wherein
the storage section has a capacity storing a plurality of times of results diagnosed by the diagnosing section and dates and times read from the clock section, for each part or function; and
the reading section reads, from the storage section, the latest diagnosed results, dates, and times from among the parts or functions other than the one or more parts or functions diagnosed at this time.

4. A multifunction product according to claim 1, wherein
the storage section has a capacity storing a plurality of times of results diagnosed by the diagnosing section and dates and times read from the clock section, for each part or function; and
a diagnosis history of each part or function is obtained from the stored contents of the storage section.

5. A multifunction product according to claim 1, wherein
the printing data editing section distinguishes the diagnosed results, dates, and times of the one or more parts or functions diagnosed at this time from the diagnosed results, dates, and times of the parts or functions other than the one or more parts or functions diagnosed at this time, by editing the diagnosed results, dates, and times of the one or more parts or functions diagnosed at this time into data to be printed in an emphasized manner.

6. A multifunction product according to claim 5, wherein
the storage section has a capacity storing a plurality of times of results diagnosed by the diagnosing section and dates and times read from the clock section, for each part or function; and
the reading section reads, from the storage section, the latest diagnosed results, dates, and times from among the parts or functions other than the one or more parts or functions diagnosed at this time.

7. A multifunction product according to claim 5, wherein
the storage section has a capacity storing a plurality of times of results diagnosed by the diagnosing section and dates and times read from the clock section, for each part or function; and
a diagnosis history of each part or function is obtained from the stored contents of the storage section.

8. A method for use in a multifunction product, comprising:
individually designating parts or functions to be diagnosed from among a plurality of parts or functions constituting a device;
self-diagnosing whether or not the designated one or more parts or functions are operating normally or not, by executing tests;
storing, in a storage section, the self-diagnosed results along with dates and times read form a clock section which counts a date and time for each part or function;
when diagnosed results and the dates and times of one or more parts or functions are newly stored in the storage section, reading, from the storage section, diagnosed results, dates, and times of the one or more parts or functions diagnosed at this time, and diagnosed results, dates, and times of parts or functions other than the one ore more parts or functions diagnosed at this time; and
preparing and outputting, to a printer, printing data which distinguishes and prints the read diagnosed results, dates, and times of the one or more parts or functions diagnosed at this time, and the diagnosed results, dates, and times of the parts or functions other than the one or more parts or functions diagnosed at this time.

9. A method for use in a multifunction product according to claim 8, wherein
the read diagnosed results, dates, and times of the one or more parts or functions diagnosed at this time, and the diagnosed results, dates, and times of the parts or functions other than the one or more parts or functions diagnosed at this time are rearranged in order of the dates, and are distinguished from one another.

10. A method for use in a multifunction product according to claim 8, wherein
the diagnosed results, dates, and times of the one or more parts or functions diagnosed at this time, and the diagnosed results, dates, and times of the parts or functions other than the one or more parts or functions diagnosed at this time are distinguished from one another by editing the diagnosed results, dates, and times of the one or more parts or functions diagnosed at this time into data to be printed in an emphasized manner.
